(19) United States
(12) Patent Application Publication
(10) Pub. No.: US 2007/0238821 A1
(43) Pub. Date: Oct. 11, 2007

(54) Anti-tarnishing device

(76) Inventor: Francis J. Houlihan, Barrington, IL (US)

Correspondence Address: BANNER & WITCOFF, LTD., TEN SOUTH WACKER DRIVE, SUITE 3000, CHICAGO, IL, 60606, US

(21) Appl. No.: 11/401,637

(22) Filed: Apr. 11, 2006

(51) Int. Cl. C08K 3/22

(52) U.S. Cl. 524/430

(57) ABSTRACT

An anti-tarnishing device, made of a carrier, and a chemical composition infused into that carrier. The carrier is preferably a cellulosic block. The chemical composition preferably comprises an alkylene glycol, and a Group I metal sorbate. The anti-tarnishing device inhibits the formation of tarnish on precious metals, including but not limited to articles made of sterling silver.

### TECHNICAL FIELD

The invention relates to a device that can be used for inhibiting the tarnishment of articles made of precious metals, such as but not limited to articles made of sterling silver. The invention is particularly suitable for placement into, and the inhibition of tarnishment of precious metal articles contained within, an enclosed jewelry case.

### BACKGROUND OF THE INVENTION

Articles made of certain precious metals, such as those made of sterling silver, are subject to discoloration and corrosion. This corrosion is due to the reaction of those metals with hydrogen sulfide, oxygen, and other chemicals, all of which are typically present in the ambient air. This corrosion results in the creation of a dull, black coating onto the surfaces of flatware, platters, jewelry, and other articles made of such precious metals.

Sterling silver flatware is typically used infrequently, on special occasions. In the extended time periods between such uses, this dull, black coating can become rather thick and difficult to remove. As a result, in order to restore the cosmetic attractiveness of the sterling silver flatware or other sterling silver articles, the user must remove the coating with, for example, an abrasive silver polish.

Sterling silver jewelry is stored and displayed in commercial glass jewelry cases. Jewelry retailers want to avoid the time, inconvenience, and expense needed to continuously polish and remove corrosion from items displayed in their jewelry cases. Accordingly, there is a need for a solution to this persistent problem.

Generally relevant United States patents and applications include United States Patent Application Nos. 2003/0220436 A1; 2003/0207974 A1; 2004/0157018 A1; 2004/0063837 A1; and U.S. Pat. Nos. 3,361,581 and 2,987,374.

### SUMMARY OF THE INVENTION

The invention is an anti-tarnishing device. The device includes a carrier, which is preferably, but not necessarily, a cellulosic block. The carrier or cellulosic block is infused with a chemical composition. This chemical composition is of the type whose vapors appear to prevent, or at least inhibit, the tarnishment of a metal.

Preferably, the cellulosic block is made of a combination of bleached cotton and wood pulp. It is believed, however, that any material that both absorbs a liquid, and then permits the emission of the vapor of that liquid from that material, will serve as a suitable carrier.

The chemical composition may be made of an alkylene glycol, and a Group I metal sorbate. This composition may also include a Group I metal carbonate. The chemical composition may further include a chemical selected from the group consisting of either benzotriazole, carboxy benzotriazole, zinc carbonate, or cyclohexylammonium benzoate.

While any Group I metal sorbate may be used, a most preferred Group I metal sorbate is potassium sorbate. In addition, while any alkylene glycol may be used, the most preferred alkylene glycol is propylene glycol.

The most preferred chemical composition comprises, by weight, 10 to 25%. propylene glycol; 60 to 80% water; 5 to 10% potassium sorbate; and 3 to 10% potassium carbonate.

For cosmetic purposes, i.e., to enhance the appearance of the carrier or the cellulosic block, the chemical composition can further include from 0.01 to 1% of a colorant. The colorant is preferably a dye, and is most preferably a pylam black dye.

The most preferred embodiment of the invention includes, as its chemical composition, by weight, 11.25% propylene glycol; 77.38% water; 7.50% potassium sorbate; 3.75% potassium carbonate; and 0.12% pylam black dye.

Another aspect of the invention is a tarnish inhibiting article effective to protect a surface of a precious metal object, such as a metal object containing in excess of 90% silver. When the surface of the metal object is exposed to vapors being emitted by the tarnish-inhibiting article, and in a sealed environment, those vapors apparently inhibit the formation of tarnish. This inhibiting effect occurs even in an oxygen- and hydrogen sulfide-containing atmosphere, as is often found in the ambient air. The tarnish-inhibiting article comprises a carrier, preferably a cellulosic block. A chemical composition is infused in, or dispersed within, the carrier.

A still further aspect of the invention is a method of inhibiting the tarnishment of an article made of a precious metal, when that article is contained within an enclosed volume. The method comprises the placement of a chemically-infused cellulosic block within that enclosed volume. Vapors from the chemical composition contained within that block are released into the enclosed volume, and inhibit the formation of tarnishes on the precious metals.

The chemical composition used for the above method may be the same chemical composition infused into the anti-tarnishing devices of the invention.

Other features and advantages of the invention will be apparent from the following specification.

### DETAILED DESCRIPTION OF PREFERRED EMBODIMENT

This invention covers many different possible embodiments. This specification describes in detail preferred embodiments of the invention. It should be understood, however, that the present disclosure is to be considered as an example of the principles of the invention. The embodiments illustrated in this specification are not intended to limit the broadest aspect of the invention. It is the claims that determine the broadest aspect of the invention.

The invention is an anti-tarnishing device. The anti-tarnishing device may be used for any suitable purpose. It is preferably used, however, to inhibit or prevent the formation of tarnish on items made of precious metals, including but not limited to sterling silver, and contained, stored, or displayed within enclosures.

The anti-tarnishing device of the invention preferably includes both a carrier and a chemical composition.

The carrier may be any suitable two- or three-dimensional structure. The carrier is preferably a product that both (a) absorbs a liquid chemical composition; and (b) subsequently permits the emission of the vapor of that liquid from that carrier.

The most preferred carrier is a cellulosic block or cube, made by EMI Specialty Papers, of 4 Old Mill Road, in Redding, Conn. Each cube has dimensions of approximately 2″ long by 1″ wide by 0.350″ thick. The cube is made of a sponge-like, porous product, described by its manufacturer as a “cellulose (cotton & wood) with synthetic fiber.” More particularly, the MSDS issued by EMI Specialty Papers relating to this product discloses that it is “a blend of bleached cotton, wood pulp, and synthetic fibers with FDA approved binders.”

The carrier or cellulosic block is preferably infused with a chemical composition. This chemical composition is of the type that apparently prevents, or at the very least inhibits, the tarnishment of a precious metal, such as but not limited to fine silver or sterling silver.

The chemical composition may comprise a Group I metal sorbate; and an alkylene glycol. The chemical composition may also include a Group I metal carbonate. With respect to the Group I metal sorbate, any Group I metal may be used, but it is believed that the preferred Group I metal sorbates are lithium sorbate, sodium sorbate, or potassium sorbate. The most preferred Group I metal sorbate is potassium sorbate.

With respect to the Group I metal carbonate, any Group I metal may be used, but it is believed that preferred Group I metal carbonates are lithium carbonate, sodium carbonate, or potassium carbonate. The most preferred Group I metal carbonate is potassium carbonate.

As indicated above, the chemical composition may also include an alkylene glycol. While any suitable aklylene glycol may be used, the preferred alkylene glycols are the lower alkylene glycols, such as ethylene glycol, methylene glycol, propylene glycol, and butylene glycol. The most preferred alkylene glycol is propylene glycol.

Furthermore, the chemical composition may optionally include a chemical selected from the group consisting of either benzotriazole, carboxy benzotriazole, zinc carbonate, or cyclohexylammonium benzoate.

A preferred chemical composition comprises, by weight, 10 to 25%. propylene glycol; 60 to 80% water; 5 to 10% potassium sorbate; and 3 to 10% potassium carbonate.

For cosmetic purposes, the chemical composition can further include from 0.01 to 1% of a colorant. The colorant is preferably a dye, and is most preferably a pylam black dye. This dye is intended to enhance the appearance of the carrier, and especially the appearance of the cellulosic block.

In the most preferred embodiment of the device of the invention, the chemical composition includes, by weight, 11.25% propylene glycol; 77.38% water; 7.50% potassium sorbate; 3.75% potassium carbonate; and 0.12% pylam black dye.

When the anti-tarnishing device of the invention can be used to effectively protect a surface of a metal object containing in excess of 90% silver. When the surface of the metal object is exposed to the tarnish-inhibiting device, in a sealed environment, the device inhibits the formation of tarnish, even in an oxygen- and hydrogen sulfide-containing atmosphere.

Preferably, the anti-tarnishing device of the invention is placed into an enclosed volume, such as a jewelry case. Ideally, the block is positioned at a distance of twelve to eighteen inches from, for example, a sterling silver item to be protected.

The preferred embodiment of the anti-tarnishing device of the invention will inhibit the formation of tarnish in a ten (10) cubic foot volume of enclosed space for a period of from three to six months.

The mechanism of the corrosion inhibition action of the invention is not fully understood. However, it appears that vapors from the chemical composition are released into the enclosed volume, and that those vapors inhibit the formation of tarnishes on the precious metals.

The method of manufacturing the anti-tarnishing device is simple, and does not require expensive or complex equipment.

First, the chemical composition is manufactured, by merely blending its ingredients. The chemical composition is next placed into a container.

The cellulosic block or other carrier is then inserted into that container. The cellulosic block should be completely covered by, i.e., immersed within, the chemical composition.

The cellulosic block is kept in that container until that block is saturated with the chemical composition. The cellulosic block is highly absorbent. Thus, typically, the cellulosic block will be saturated with the chemical composition within ten to sixty seconds after its immersion into that composition.

When fully saturated, the block contains about 13.5 grams of the chemical composition per cubic inch of the block.

After the block has been saturated, it is removed from the chemical composition, and then placed upon a grate. The saturated block is left upon this grate, to drain overnight. During this draining period, some of the excess liquid drips out of the block.

After the block has been allowed to drip dry overnight, the block is placed into a drying oven at 200-250° F. The block is dried in this oven for a time period of approximately four hours.

After this block is cooled in the ambient air, it is ready for use.

It is self-evident that after the draining and heat drying steps, the amount of chemicals and water in the finished block will be less than the amount of chemicals and water in the initially treated, saturated block. Particularly, after both drip-drying overnight, and heat-drying in the oven, the weight of the chemical composition remaining in the block falls to about two (2) grams of chemical composition per cubic inch of the block.

Most of this weight loss results from the evaporation of the water. It is believed, however, that some of the other components of the chemical composition, including but not limited to the glycol, will also evaporate.

For the purposes of this specification and its claims, when specific amounts of chemicals are referred to, those amounts correspond to the amounts of those chemicals in the composition with which the cellulosic block or carrier is saturated. For example, a claim that refers to 77.38% water refers to the amount of water in the chemical composition itself, immediately after the block has been immersed in the chemical composition.

During drip drying and heating, water evaporates, and is removed from the cellulosic block. As a result, the amount of water in the residual chemical composition (i.e., the chemical composition that remains in the dried block) will be substantially less than 77.38%.

The inventors have devised various useful chemical compositions for the invention. Each of these chemical compositions are generally suitable for the purposes of the invention.

It has been found, however, that the most suitable chemical composition of the invention comprises 11.25% propylene glycol; 77.38% water; 7.50% potassium sorbate; 3.75% potassium carbonate; and, for cosmetic purposes, 0.12% pylam black dye.

Any other suitable dye or colorant can be used.

A second suitable chemical composition is comprised of 20% propylene glycol, 5% potassium sorbate, 5% potassium carbonate, and 70% water. Dye may also be added to this second chemical composition, or to any of the following chemical compositions.

A third suitable chemical composition is comprised of 20% propylene glycol, 10% potassium sorbate, 10% potassium carbonate, and 60% water.

A fourth suitable chemical composition is comprised of 20% propylene glycol, 10% potassium sorbate, 0.5% benzotriazole, and 69.5% water.

A fifth suitable chemical composition is comprised of 20% propylene glycol, 10% potassium sorbate, 0.5% carboxy benzotriazole, and 69.5% water.

A sixth suitable chemical composition is comprised of 20% propylene glycol, 8% potassium sorbate, 2% cyclohexylammonium benzoate, and 70% water.

A seventh suitable chemical composition is comprised of 20% propylene glycol, 8% potassium sorbate, 2% zinc carbonate, and 70% water.

While the specific embodiments have been illustrated and described, numerous modifications come to mind without significantly departing from the spirit of the invention, and the scope of protection is only limited by the scope of the accompanying Claims.

What is claimed is:

1. An anti-tarnishing device, comprising: (a) a carrier; and (b) a chemical composition infused into that cellulosic block, the chemical composition being suitable for the prevention of the tarnishment of a metal.

2. The anti-tarnishing device of claim 1, wherein the chemical composition comprises an alkylene glycol and a Group I metal sorbate.

3. The anti-tarnishing device of claim 1, wherein said chemical composition comprises, by weight, 10 to 25%. propylene glycol; 60 to 80% water; 5 to 10% potassium sorbate; and 3 to 10% potassium carbonate.

4. The anti-tarnishing device of claim 3, further comprising 0.01 to 1% dye.

5. The anti-tarnishing device of claim 4, wherein said dye is pylam black dye.

6. The anti-tarnishing device of claim 1, wherein said chemical composition comprises, by weight, 11.25% propylene glycol; 77.38% water; 7.50% potassium sorbate; 3.75% potassium carbonate; and 0.12% pylam black dye.

7. The anti-tarnishing device of claim 2, wherein said chemical composition further comprises a Group I metal carbonate.

8. The anti-tarnishing device of claim 1, wherein said chemical composition comprises a Group I metal sorbate, and benzotriazole.

9. The anti-tarnishing device of claim 1, wherein said chemical composition comprises an alkylene glycol, a Group I metal sorbate, and carboxy benzotriazole.

10. The anti-tarnishing device of claim 1, wherein said chemical composition comprises an alkylene glycol, a Group I metal sorbate, and cyclohexylammonium benzoate.

11. The anti-tarnishing device of claim 1, wherein said chemical composition comprises an aklylene glycol, a Group I metal sorbate, and zinc carbonate.

12. The anti-tarnishing device of claim 7, wherein said Group I metal carbonate is potassium carbonate.

13. The anti-tarnishing device of claim 2, wherein said Group I metal sorbate is potassium sorbate.

14. The anti-tarnishing device of claim 2, wherein said alkylene glycol is propylene glycol.

15. A tarnish inhibiting article effective to protect a surface of a precious metal object against tarnishing in an oxygen- and hydrogen sulfide-containing atmosphere, the tarnish-inhibiting article comprising: a cellulosic block; and further comprising, dispersed within that cellulosic block, a chemical composition.

16. The tarnish inhibiting article of claim 15, wherein said chemical composition comprises an alkylene glycol; and a Group I metal sorbate.

17. The tarnish inhibiting article of claim 16, wherein the Group I metal sorbate is potassium sorbate.

18. The tarnish inhibiting article of claim 16, wherein the chemical composition further comprises potassium carbonate.

19. The tarnish inhibiting article of claim 16, wherein the chemical composition further comprises benzotriazole.

20. The tarnish inhibiting article of claim 16, wherein the chemical composition further comprises carboxy benzotriazole.

21. The tarnish inhibiting article of claim 16, wherein the chemical composition further comprises cyclohexylammonium benzoate.

22. The tarnish inhibiting article of claim 16, wherein the chemical composition further comprises zinc carbonate.

23. A method of inhibiting the tarnishment of a precious metal contained within an enclosed volume, comprising the placement of a chemically-infused cellulosic block within that enclosed volume.

24. The method of claim 23, wherein the cellulosic block is infused with a chemical composition comprising an alkylene glycol; and a Group I metal sorbate.

25. The method of claim 24, wherein the chemical composition further comprises a Group I metal carbonate.

26. The method of claim 24, wherein the chemical composition further comprises benzotriazole.

27. The method of claim 24, wherein the chemical composition further comprises carboxy benzotriazole.

28. The method of claim 24, wherein the chemical composition further comprises cyclohexylammonium benzoate.

29. The method of claim 24, wherein the chemical composition further comprises zinc carbonate.
